(19) United States
(12) Patent Application Publication
(10) Pub. No.: US 2017/0286433 A1
(43) Pub. Date: Oct. 5, 2017

(54) SYSTEM AND METHOD FOR SHARING IMAGES

(71) Applicant: Cortica, Ltd., Tel Aviv (IL)

(72) Inventors: Igal RAICHELGAUZ, Tel Aviv (IL); Karina ODINAEV, Tel Aviv (IL); Yehoshua Y ZEEVI, Haifa (IL)

(73) Assignee: Cortica, Ltd., Tel Aviv (IL)

(21) Appl. No.: 15/628,171

(22) Filed: Jun. 20, 2017

Related U.S. Application Data
(63) Continuation-in-part of application No. 13/770,603, filed on Feb. 19, 2013.
Application No. 13/770,603 is a continuation-in-part of application No. 13/624,397, filed on Sep. 21, 2012, now Pat. No. 9,191,626.
Application No. 13/624,397 is a continuation-in-part of application No. 13/344,400, filed on Jan. 5, 2012, now Pat. No. 8,959,037.
Application No. 13/344,400 is a continuation of application No. 12/434,221, filed on May 1, 2009, now Pat. No. 8,112,376.
Application No. 13/624,397 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 13/624,397 is a continuation-in-part of application No. 12/084,150, filed on Apr. 7, 2009, now Pat. No. 8,655,801.
(60) Provisional application No. 62/352,033, filed on Jun. 20, 2016.

(30) Foreign Application Priority Data
Oct. 26, 2005 (IL) 171577
Jan. 29, 2006 (IL) 173409
Aug. 21, 2007 (IL) 185414

(51) Int. Cl. G06F 17/30; H04H 60/46; H04H 60/66; H04N 7/173; H04N 21/258; H04N 21/2668; H04N 21/466; H04N 21/81; H04H 20/26; H04H 60/37; H04H 60/56; H04H 20/10; H04L 29/08

(52) U.S. Cl. CPC G06F 17/30056; H04H 20/103; H04H 60/46; H04H 60/66; H04N 7/17318; H04N 21/25891; H04N 21/2668; H04L 67/10; H04N 21/8106; H04H 20/26; H04H 60/37; H04H 60/56; H04N 21/466

(57) ABSTRACT

A system and method for sharing an image showing at least one person. The method includes generating at least one signature for the image; determining, based on the generated at least one signature, at least one personal identifier of each of the at least one person, wherein each personal identifier uniquely identifies the respective person; searching, using the determined personal identifiers, for at least one sharing identifier in at least one data source, wherein each sharing identifier indicates information for sharing the image with one of the at least one person; and sending a notification indicating the image using the at least one sharing identifier.

### CROSS-REFERENCE TO RELATED APPLICATIONS

This application claims the benefit of U.S. Provisional Application No. 62/352,033 filed on Jun. 20, 2016. This application is also a continuation-in-part of U.S. patent application Ser. No. 13/770,603 filed on Feb. 19, 2013, now pending, which is a continuation-in-part (CIP) of U.S. patent application Ser. No. 13/624,397 filed on Sep. 21, 2012, now U.S. Pat. No. 9,191,626. The Ser. No. 13/624,397 Application is a CIP of:

(a) U.S. patent application Ser. No. 13/344,400 filed on Jan. 5, 2012, now U.S. Pat. No. 8,959,037, which is a continuation of U.S. patent application Ser. No. 12/434,221 filed on May 1, 2009, now U.S. Pat. No. 8,112,376;

(b) U.S. patent application Ser. No. 12/195,863 filed on Aug. 21, 2008, now U.S. Pat. No. 8,326,775, which claims priority under 35 USC 119 from Israeli Application No. 185414, filed on Aug. 21, 2007, and which is also a continuation-in-part of the below-referenced U.S. patent application Ser. No. 12/084,150; and

(c) U.S. patent application Ser. No. 12/084,150 having a filing date of Apr. 7, 2009, now U.S. Pat. No. 8,655,801, which is the National Stage of International Application No. PCT/IL2006/001235, filed on Oct. 26, 2006, which claims foreign priority from Israeli Application No. 171577 filed on Oct. 26, 2005, and Israeli Application No. 173409 filed on Jan. 29, 2006.

All of the applications referenced above are herein incorporated by reference.

### TECHNICAL FIELD

The present disclosure relates generally to sharing multimedia content elements, and more particularly to sharing multimedia content elements based on users shown in the multimedia content elements.

### BACKGROUND

As content available over the Internet continues to exponentially grow in size and content, the task of finding relevant content has become increasingly cumbersome. Further such content may not always be sufficiently organized or identified, thereby resulting in missed content.

In particular, users of social media often share images showing other users. For example, a video titled “Birthday Party” may show a user with his or her friends and family. Often, it is desirable to share such images and videos with the people shown in the images. However, such sharing typically requires the user to tag the images in order to identify the people with which to share the images. Tagging may be inconvenient for the user, and manual tagging may result in missed or otherwise inaccurate tags. Further, although some automated tagging solutions exist, such solutions may not accurately identify some or all of the people shown in images.

Moreover, it may be desirable to share images uploaded to one social media platform with other users of the same social media platform that are not contacts of the sharing user or to share images from one social media platform with people shown in the images having accounts for other social media platforms. For example, a user having a Facebook® account may want to share an image uploaded to Facebook® and showing his friend via the friend's Instagram® account.

It would be therefore advantageous to provide a solution for accurately recommending tags that matches the multimedia content elements.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for sharing an image showing at least one person. The method comprises: generating at least one signature for the image; determining, based on the generated at least one signature, at least one personal identifier of each of the at least one person, wherein each personal identifier uniquely identifies the respective person; searching, using the determined personal identifiers, for at least one sharing identifier in at least one data source, wherein each sharing identifier indicates information for sharing the image with one of the at least one person; and sending a notification indicating the image using the at least one sharing identifier.

Certain embodiments disclosed herein also include a non-transitory computer readable medium having stored thereon causing a processing circuitry to execute a process, the process comprising: generating at least one signature for an image showing at least one person; determining, based on the generated at least one signature, at least one personal identifier of each of the at least one person, wherein each personal identifier uniquely identifies the respective person; searching, using the determined personal identifiers, for at least one sharing identifier in at least one data source, wherein each sharing identifier indicates information for sharing the image with one of the at least one person; and sending a notification indicating the image using the at least one sharing identifier.

Certain embodiments disclosed herein also include a system for sharing an image showing at least one person. The system comprises: a processing circuitry; and a memory, the memory containing instructions that, when executed by the processing circuitry, configure the processing circuitry to: generate at least one signature for the image; determine, based on the generated at least one signature, at least one personal identifier of each of the at least one person, wherein each personal identifier uniquely identifies the respective person; search, using the determined personal identifiers, for at least one sharing identifier in at least one data source, wherein each sharing identifier indicates information for sharing the image with one of the at least one person; and send a notification indicating the image using the at least one sharing identifier.

### BRIEF DESCRIPTION OF THE DRAWINGS

The subject matter that is regarded as the disclosure is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments herein.

FIG. 2 is a schematic diagram of an image sharing system according to an embodiment.

FIG. 3 is a flowchart illustrating a method for sharing images according to an embodiment.

FIG. 4 is a block diagram depicting the basic flow of information in the signature generator system.

FIG. 5 is a diagram showing the flow of patches generation, response vector generation, and signature generation in a large-scale speech-to-text system.

### DETAILED DESCRIPTION

It is important to note that the embodiments disclosed herein are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

A system and method for sharing images. An image to be shared is analyzed to generate signatures for the image. Based on the generated signatures, personal identifiers of one or more people shown in the image are determined. One or more data sources are searched based on the personal identifiers to determine at least one sharing identifier of each person. The sharing identifiers are utilized to send or otherwise share the image for each identified person. In some embodiments, a notification including or otherwise indicating the image may be sent to each person using the sharing identifiers.

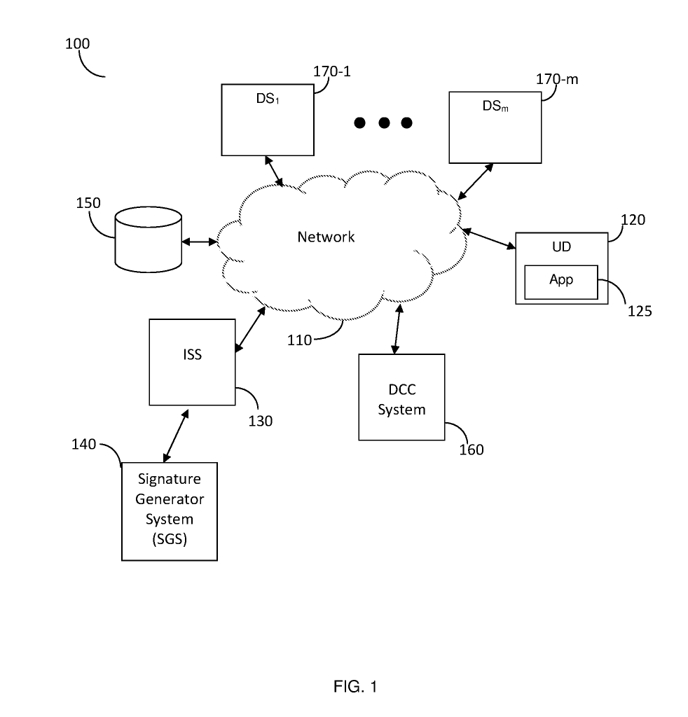

FIG. 1 is an example network diagram 100 utilized to describe the various disclosed embodiments. The network diagram 100 includes a user device 120, an image sharing system 130, a database 150, a deep content classification (DCC) system 160, and a plurality of data sources 170-1 through 170-m (hereinafter referred to individually as a data source 170 and collectively as data sources 170, merely for simplicity purposes) communicatively connected via a network 110. The network 110 may be, but is not limited to, the Internet, the world-wide-web (WWW), a local area network (LAN), a wide area network (WAN), a metro area network (MAN), and other networks capable of enabling communication between the elements of the network diagram 100.

The user device 120 may be, but is not limited to, a personal computer (PC), a personal digital assistant (PDA), a mobile phone, a smart phone, a tablet computer, a wearable computing device and other kinds of wired and mobile appliances, equipped with image capturing, browsing, viewing, listening, filtering, managing, and other capabilities that are enabled as further discussed herein below. The user device 120 may have installed thereon an application 125 such as, but not limited to, a web browser. The application 125 may be configured to store images in, for example, the data sources 170, to send images to the image sharing system 130, or both. For example, the application 125 may be a web browser through which a user of the user device 120 accesses a social media website and uploads multimedia content elements when one of the data sources 170 is associated with the social media website.

The database 150 may be a personal identifier database storing reference signatures and associated predetermined personal identifiers. Each reference signature is generated for a reference image (e.g., as described further herein below) showing a person such that the personal identifiers associated with the reference signature uniquely identify the person shown in the respective reference image. The database 150 may be updated periodically by, e.g., adding new reference signatures for each personal identifier based on newly received reference images showing each respective person, thereby allowing the reference signatures to accurately represent a person as, e.g., the person's facial features changes over time.

In an embodiment, the image sharing system 130 includes a processing circuitry coupled to a memory (e.g., the processing circuitry 610 and the memory 620 as shown in FIG. 6). The memory contains instructions that can be executed by the processing circuitry. In a further embodiment the image sharing system 130 may include an array of at least partially statistically independent computational cores configured as described in more detail herein below.

In an embodiment, the image sharing system 130 is communicatively connected to a signature generator system (SGS) 140, which is utilized by the image sharing system 130 to perform the various disclosed embodiments. Specifically, the signature generator system 140 is configured to generate signatures to multimedia content elements and includes a plurality of computational cores, each computational core having properties that are at least partially statistically independent of each other core, where the properties of each core are set independently of the properties of each other core.

The signature generator system 140 may be communicatively connected to the image sharing system 130 directly (as shown), or through the network 110 (not shown). In another embodiment, the image sharing system 130 may further include the signature generator system 140, thereby allowing the image sharing system 130 to generate signatures for multimedia content elements.

In an embodiment, the image sharing system 130 is communicatively connected to the deep content classification system 160, which is utilized by the image sharing system 130 to perform the various disclosed embodiments. Specifically, the deep content classification system 160 is configured to create, automatically and in an unsupervised fashion, concepts for a wide variety of multimedia content elements. To this end, the deep content classification system 160 may be configured to inter-match patterns between signatures for a plurality of multimedia content elements and to cluster the signatures based on the inter-matching. The deep content classification system 160 may be further configured to reduce the number of signatures in a cluster to a minimum that maintains matching and enables generalization to new multimedia content elements. Metadata of the multimedia content elements is collected to form, together with the reduced clusters, a concept. An example deep content classification system is described further in U.S. Pat. No. 8,266,185, assigned to the common assignee, the contents of which are hereby incorporated by reference.

The deep content classification system 160 may be communicatively connected to the image sharing system 130 directly (not shown), or through the network 110 (as shown). In another embodiment, the image sharing system 130 may further include the deep content classification system 160, thereby allowing the image sharing system 130 to create a concept database and to match concepts from the concept database to multimedia content elements.

In an embodiment, the image sharing system 130 is configured to receive, from the user device 120, an image to be shared. Alternatively, the image sharing system 130 may be configured to receive, from the user device 120, an indicator of a location of the image to be shared in storage (e.g., in one of the data sources 170). In a further embodiment, the image sharing system 130 is configured to retrieve the image to be shared based on the indicator. The image may be, but is not limited to, a static image, a graphic, a video stream, a video clip, a video frame, or any other visual multimedia content element that may feature one or more people.

In an embodiment, the image sharing system 130 is configured to send the image to be shared to the signature generator system 140, to the deep content classification system 160, or both. The image sharing system 130 is configured to receive signatures generated to the image from the signature generator system 140, to receive a signature (e.g., a signature reduced cluster) of a concept matched to the image from the deep content classification system 160, or both. In another embodiment, the image sharing system 130 may be configured to generate the signatures, to identify the signatures (e.g., by determining concepts associated with the signature reduced clusters matching the image to be shared), or a combination thereof.

Each signature represents a concept, and may be robust to noise and distortion. Each concept is a collection of signatures representing multimedia content elements and metadata describing the concept, and acts as an abstract description of the content to which the signature was generated. As a non-limiting example, a ‘Superman concept’ is a signature-reduced cluster of signatures describing elements (such as multimedia elements) related to, e.g., a Superman cartoon: a set of metadata representing proving textual representation of the Superman concept. As another example, metadata of a concept represented by the signature generated for a picture showing a bouquet of red roses is “flowers”. As yet another example, metadata of a concept represented by the signature generated for a picture showing a bouquet of wilted roses is “wilted flowers”.

It should be noted that using signatures for identifying people shown in images ensures more accurate identification of people than, for example, based on metadata alone. Specifically, the signatures, as described herein, allow for recognition and classification of multimedia content elements.

In an embodiment, based on the signatures of the image to be shared, the image sharing system 130 is configured to identify at least one person shown in the image. To this end, the image sharing system 130 may be configured to compare the generated signatures to a plurality of reference signatures associated with predetermined personal identifiers of known people to determine a personal identifier for each person shown in the image. Each of the reference signatures is generated to a reference image showing the person indicated by the associated personal identifiers. In another implementation, the concept matching the image may be compared to a plurality of concepts representing known people that are associated with predetermined personal identifiers to determine a personal identifier for each person shown in the image. The reference signatures or concepts and associated predetermined personal identifiers may be stored in, e.g., the database 150. The personal identifiers may include, but are not limited to, names, user names, identification numbers, or any other unique identifiers of people.

In an embodiment, based on the determined personal identifiers of the people shown in the image, the image sharing system 130 is configured to search through the data sources 170 for at least one sharing identifier of each person shown in the image. The sharing identifiers include information that may be utilized to share the image such as, but not limited to, email addresses (e.g., to send the image via email), phone numbers (e.g., to send the image via text or SMS message), social media account information such as user name (e.g., to send the image to one or more social media profiles of the respective people), combinations thereof, and the like. As a non-limiting example, the image sharing system may search through a server of Facebook® for a user profile of each person shown in the image.

Alternatively, the image sharing system 130 may be configured to query, e.g., the user device 120, and to receive, from the user device 120, the sharing identifiers. The querying may be based on the personal identifiers of the people shown in the images. For example, the user device 120 may be queried with a name of each person shown in the image, and the user device 120 may send an email address indicated in a contacts list with respect to each queried name.

In an embodiment, the image sharing system 130 is configured to share the image with each person shown in the image based on the sharing identifiers. The sharing may include, but is not limited to, sending the image using each sharing identifier, sending a notification including or indicating the image (e.g., a notification including a link to the image) using each sharing identifier, and the like.

It should be noted that only one user device 120 and one application 125 are described herein above with reference to FIG. 1 merely for the sake of simplicity and without limitation on the disclosed embodiments. Multiple user devices may provide multimedia content elements via multiple applications 125, and tags for each multimedia content element may be recommended to the sending user device, without departing from the scope of the disclosure.

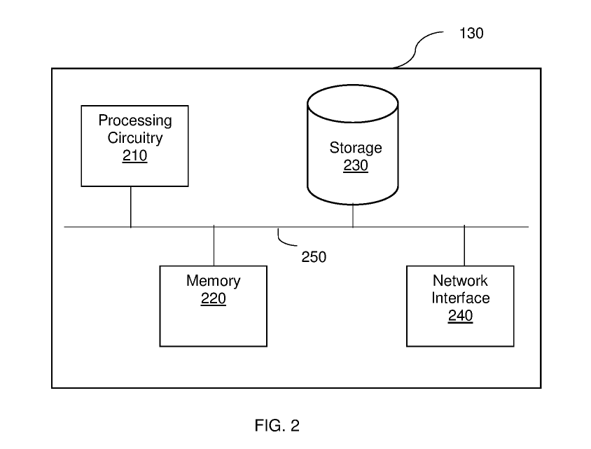

FIG. 2 is an example schematic diagram 200 of an image sharing system 130 according to an embodiment. The image sharing system 130 includes a processing circuitry 210 coupled to a memory 220, a storage 230, and a network interface 240. In an embodiment, the components of the image sharing system 130 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information. In an embodiment, the processing circuitry 210 may be realized as an array of at least partially statistically independent computational cores. The properties of each computational core are set independently of those of each other core, as described further herein above.

The memory 220 may be volatile (e.g., RAM, etc.), non-volatile (e.g., ROM, flash memory, etc.), or a combination thereof. In one configuration, computer readable instructions to implement one or more embodiments disclosed herein may be stored in the storage 230.

In another embodiment, the memory 220 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 210 to perform the various processes described herein. Specifically, the instructions, when executed, cause the processing circuitry 210 to analyze and share images as described herein.

The storage 230 may be magnetic storage, optical storage, and the like, and may be realized, for example, as flash memory or other memory technology, CD-ROM, Digital Versatile Disks (DVDs), or any other medium which can be used to store the desired information.

The network interface 240 allows the image sharing system 130 to communicate with the signature generator system 140, the deep content classification system 160, or both, for the purpose of, for example, sending multimedia content elements, receiving signatures, and the like. Further, the network interface 240 allows the image sharing system 130 to communicate with the user device 120 for the purpose of, for example, receiving images.

It should be understood that the embodiments described herein are not limited to the specific architecture illustrated in FIG. 2, and other architectures may be equally used without departing from the scope of the disclosed embodiments. In particular, the image sharing system 130 may further include a signature generator system configured to generate signatures as described herein without departing from the scope of the disclosed embodiments.

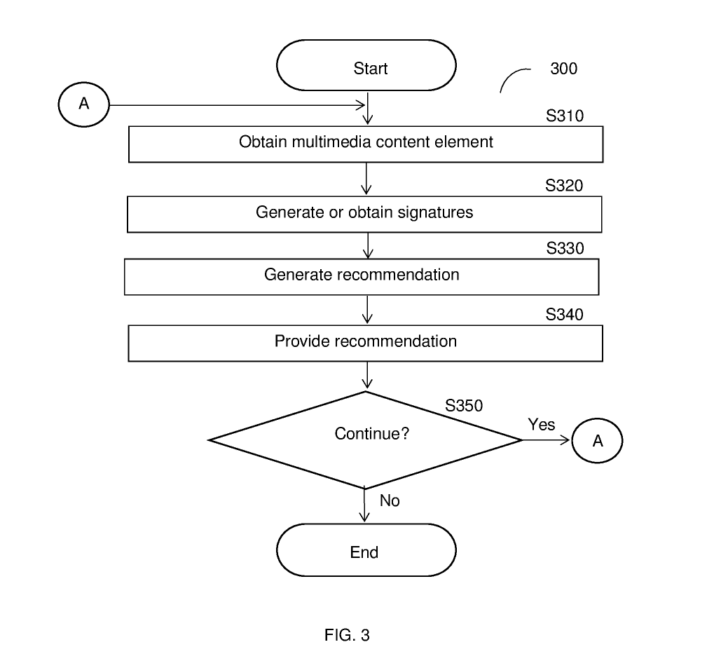

FIG. 3 depicts an example flowchart 300 illustrating a method for sharing images according to an embodiment. In an embodiment, the method is performed by the image sharing system 130.

At S310, an image to be shared is received or retrieved. The image or an indicator of the image may be received from, e.g., a user device. The indicator may be, e.g., a pointer to a location in storage. When an indicator of the image is received, the image may be retrieved based on the indicator.

At S320, at least one signature is generated for the received or retrieved image. The signatures may be generated by a signature generator system or deep content classification system.

In an embodiment, S320 includes generating the signatures via a plurality of at least partially statistically independent computational cores, where the properties of each core are set independently of the properties of the other cores. In another embodiment, S320 includes sending the multimedia content element to a signature generator system, to a deep content classification system, or both, and receiving the signatures. The signature generator system includes a plurality of at least statistically independent computational cores as described further herein. The deep content classification system is configured to create concepts for a wide variety of multimedia content elements, automatically and in an unsupervised fashion. To this end, S320 may include receiving a signature representing a concept matching the image.

At S330, based on the generated signatures, at least one personal identifier of each person shown in the image is determined. In an embodiment, S330 includes comparing the generated signatures to reference signatures of images associated with predetermined personal identifiers. The reference signatures are generated for reference images showing known people. Each personal identifier is a distinct identifier of a person.

At S340, based on the personal identifiers, at least one sharing identifier is determined for each person. The sharing identifiers include information utilized for sending or otherwise sharing the image such as, but not limited to, email addresses, phone numbers, social media account information, and the like. In an embodiment, S340 includes searching through one or more data sources using the personal identifiers.

It should be noted that using personal identifiers to identify sharing identifiers allows for determining currently used sharing identifiers of the user. Sharing identifiers such as social media account information may differ for the same user at different points in life or for different accounts. Accordingly, personal identifiers determined based on signatures generated for reference images showing a person may be more likely to accurately represent the person at any given time than sharing identifiers such as user accounts, particularly when the reference images are updated over time. For example, a person may have multiple social media accounts with the same user name, but may add or delete accounts over time such that a particular social media account may not accurately identify the user at any given point.

At S350, the image is shared with each person shown therein using the determined sharing identifiers. Sharing the image may include, but is not limited to, sending the image via, e.g., email, text message, SMS message, a social media platform, storing the image in a storage, and the like. Sharing the images may further include generating a notification including or indicating the image and sending the notification using the sharing identifiers. In some implementations, the image may not be shared with a user that provided the shared image.

As a non-limiting example, an image showing Bob Alpha, Jane Beta, and Joe Gamma is uploaded to Bob Alpha's Facebook® account. The uploaded image is received. The image is sent to a signature generator system, and signatures generated for the image are received. The signatures are compared to reference signatures generated for reference images of known people. Based on the comparison, reference signatures associated with the names “Bob Alpha,” Jane Beta,” and “Joe Gamma” are generated. The associated names are determined as personal identifiers. Based on the determined names, a Facebook® account identifier of each person is determined as a sharing identifier. The image is shared with Jane Beta and Joe Gamma using their respective Facebook® account identifiers.

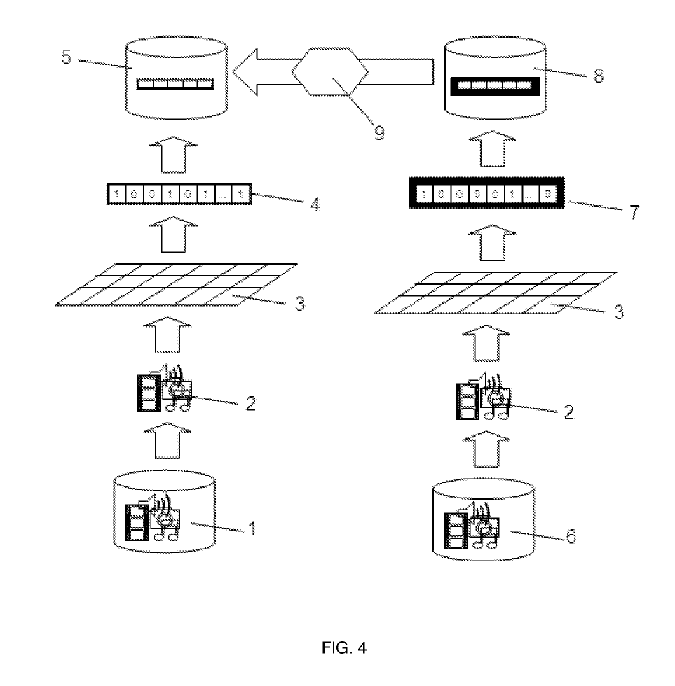

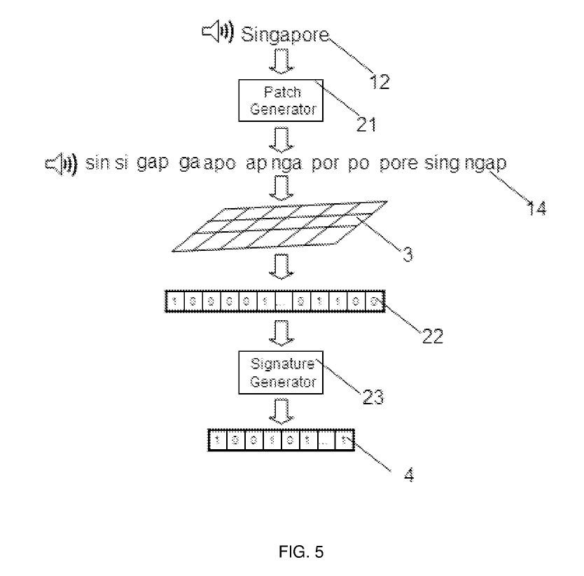

FIGS. 4 and 5 illustrate the generation of signatures for the multimedia content elements by the SGS 140 according to an embodiment. An exemplary high-level description of the process for large scale matching is depicted in FIG. 4. In this example, the matching is for a video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the computational Cores generation are provided below. The independent Cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Finally, Target Robust Signatures and/or Signatures are effectively matched, by a matching algorithm 9, to Master Robust Signatures and/or Signatures database to find all matches between the two databases.

To demonstrate an example of the signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames. In an embodiment the server 130 is configured with a plurality of computational cores to perform matching between signatures.

The Signatures' generation process is now described with reference to FIG. 5. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the server 130 and SGS 140. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3 a frame ‘i’ is injected into all the Cores 3. Then, Cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Ci={nᵢ} (1≦i≦L) may consist of a single leaky integrate-to-threshold unit (LTU) node or more nodes. The node ni equations are:

$${V}_{i} = {\sum }_{j} {w}_{ij} {k}_{j}$$

$${n}_{i} = θ ( Vi - {Th}_{x} )$$

where, θ is a Heaviside step function; wᵢⱼ is a coupling node unit (CNU) between node i and image component j (for example, grayscale value of a certain pixel j); kj is an image component ‘j’ (for example, grayscale value of a certain pixel j); Thₓ is a constant Threshold value, where ‘x’ is ‘S’ for Signature and ‘RS’ for Robust Signature; and Vi is a Coupling Node Value.

The Threshold values Thₓ are set differently for Signature generation and for Robust Signature generation. For example, for a certain distribution of Vi values (for the set of nodes), the thresholds for Signature (Th_{S}) and Robust Signature (Th_{RS}) are set apart, after optimization, according to at least one or more of the following criteria:
1: For: Vᵢ>Th_{RS}

1−p(V>Th_{S})−1−(1−ε)^{l}<<1

i.e., given that l nodes (cores) constitute a Robust Signature of a certain image I, the probability that not all of these I nodes will belong to the Signature of same, but noisy image, Ĩ is sufficiently low (according to a system's specified accuracy).
2: p(Vᵢ>Th_{RS})≈l/L
   i.e., approximately l out of the total L nodes can be found to generate a Robust Signature according to the above definition.
3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the Signature generation can be found in U.S. Pat. Nos. 8,326,775 and 8,312,031, assigned to the common assignee, which are hereby incorporated by reference.

A Computational Core generation is a process of definition, selection, and tuning of the parameters of the cores for a certain realization in a specific system and application. The process is based on several design considerations, such as:

(a) The Cores should be designed so as to obtain maximal independence, i.e., the projection from a signal space should generate a maximal pair-wise distance between any two cores' projections into a high-dimensional space.

(b) The Cores should be optimally designed for the type of signals, i.e., the Cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.

(c) The Cores should be optimally designed with regard to invariance to a set of signal distortions, of interest in relevant applications.

A detailed description of the Computational Core generation and the process for configuring such cores is discussed in more detail in U.S. Pat. No. 8,655,801 referenced above.

It should be noted that various embodiments described herein are discussed with respect to sharing an image merely for simplicity purposes and without limitation on the disclosed embodiments. Other types of multimedia content elements and, in particular, visual multimedia content elements such as videos, may be analyzed and shared with people featured therein, without departing from the scope of the disclosure.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the disclosed embodiments and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

What is claimed is:

1. A method for sharing an image showing at least one person, comprising:
generating at least one signature for the image;
determining, based on the generated at least one signature, at least one personal identifier of each of the at least one person, wherein each personal identifier uniquely identifies the respective person;
searching, using the determined personal identifiers, for at least one sharing identifier in at least one data source, wherein each sharing identifier indicates information for sharing the image with one of the at least one person; and
sending a notification indicating the image using the at least one sharing identifier.

2. The method of claim 1, wherein the notification includes at least one of: the image, and a pointer to a location in storage of the image.

3. The method of claim 1, wherein each personal identifier is any one of: a name, a username, and a numerical identifier.

4. The method of claim 1, wherein each sharing identifier is any one of: an email address, a phone number, and a social media account identifier.

5. The method of claim 1, wherein each signature represents a concept, wherein each concept is a collection of signatures and metadata representing the concept.

6. The method of claim 1, wherein each signature is generated by a signature generator system, wherein the signature generator system includes a plurality of at least statistically independent computational cores, wherein the properties of each core are set independently of the properties of each other core.

7. The method of claim 6, wherein generating the at least one signature further comprises:
sending the image to the signature generator system; and
receiving, from the signature generator system, the at least one signature.

8. The method of claim 1, wherein determining the at least one personal identifier of each of the at least one person further comprises:
comparing the generated at least one signature to a plurality of reference signatures, wherein each reference signature is associated with at least one predetermined personal identifier, wherein each determined personal identifier is one of the predetermined personal identifiers associated with a reference signature matching at least a portion of the generated at least one signature above a predetermined threshold.

9. A non-transitory computer readable medium having stored thereon instructions for causing a processing circuitry to execute a process, the process comprising:
generating at least one signature for an image showing at least one person;
determining, based on the generated at least one signature, at least one personal identifier of each of the at least one person, wherein each personal identifier uniquely identifies the respective person;
searching, using the determined personal identifiers, for at least one sharing identifier in at least one data source, wherein each sharing identifier indicates information for sharing the image with one of the at least one person; and
sending a notification indicating the image using the at least one sharing identifier.

10. A system for sharing an image showing at least one person, comprising:
a processing circuitry; and
a memory connected to the processing circuitry, the memory containing instructions that, when executed by the processing circuitry, configure the system to:
generate at least one signature for the image;
determine, based on the generated at least one signature, at least one personal identifier of each of the at least one person, wherein each personal identifier uniquely identifies the respective person;
search, using the determined personal identifiers, for at least one sharing identifier in at least one data source, wherein each sharing identifier indicates information for sharing the image with one of the at least one person; and
send a notification indicating the image using the at least one sharing identifier.

11. The system of claim 10, wherein the notification includes at least one of: the image, and a pointer to a location in storage of the image.

12. The system of claim 10, wherein each personal identifier is any one of: a name, a username, and a numerical identifier.

13. The system of claim 10, wherein each sharing identifier is any one of: an email address, a phone number, and a social media account identifier.

14. The system of claim 10, wherein each signature represents a concept, wherein each concept is a collection of signatures and metadata representing the concept.

15. The system of claim 10, further comprising:
a signature generator system, wherein each signature is generated by the signature generator system, wherein the signature generator system includes a plurality of at least statistically independent computational cores, wherein the properties of each core are set independently of the properties of each other core.

16. The system of claim 15, wherein the system is further configured to:
send the image to the signature generator system; and
receive, from the signature generator system, the at least one signature.

17. The system of claim 10, wherein the system is further configured to:
compare the generated at least one signature to a plurality of reference signatures, wherein each reference signature is associated with at least one predetermined personal identifier, wherein each determined personal identifier is one of the predetermined personal identifiers associated with a reference signature matching at least a portion of the generated at least one signature above a predetermined threshold.
